(19) United States
(12) Patent Application Publication
(10) Pub. No.: US 2011/0032183 A1
(43) Pub. Date: Feb. 10, 2011

(54) METHOD, SYSTEM, AND STORAGE MEDIUM FOR A COMIC BOOK READER PLATFORM

(75) Inventor: Michael Murphey, Austin, TX (US)

Correspondence Address: HULSEY IP INTELLECTUAL PROPERTY LAWYERS, P.C., 919 Congress Avenue, Suite 919, AUSTIN, TX, 78701, US

(73) Assignee: IVERSE MEDIA, LLC, Waco, TX (US)

(21) Appl. No.: 12/850,555

(22) Filed: Aug. 4, 2010

Related U.S. Application Data
(60) Provisional application No. 61/231,188, filed on Aug. 4, 2009.

(51) Int. Cl. G06F 3/01

(52) U.S. Cl. 345/156

(57) ABSTRACT

The invention pertains to a method, system, and storage medium for a comic book reader platform that retains the unique and highly sought after look and flow of traditional printed comic books in a mobile hand-held device. The invention is capable of displaying the comic book in a full page or cell-by-cell configuration depending on the orientation and/or desire of the particular user and leverages advanced features provided by today's mobile hand-held devices such as motion sensitivity, orientation changing, touch screens, etc. The invention also provides the ability to store multiple comic books and allows the user to switch between them with ease.

### CROSS REFERENCE TO RELATED APPLICATIONS

This application claims priority to U.S. Provisional Application No. 61/231,188, filed on Aug. 4, 2009, entitled “METHOD, SYSTEM, AND STORAGE MEDIUM FOR A COMIC BOOK READER PLATFORM” and incorporated herein for all purposes.

### FIELD OF THE INVENTION

The present invention relates generally to comic books, and more specifically to a system for reading comic books on a hand-held electronic mobile device.

### BACKGROUND OF THE INVENTION

A comic book is a magazine that contains narrative artwork usually accompanied by dialog (e.g. a word balloon). Normally, comic books are a series of cells explaining a portion of the over all story. Several cells could appear on the same page, and coupled with other pages, tell the story.

Comic books have been around for some time and are well known in the art. Traditional comic books appear in printed hard copy format. Many of these titles are highly coveted for their scarcity or other collectible reasons (e.g. misprints, subject matter, etc.). However, the traditional printed format has experienced considerable decline from its golden years.

With the advent of electronic and digital media, demand has grown for alternate format comic books. Existing digital “readers” fail to provide a mobile solution that integrates the look and feel of a traditional printed comic book. Unfortunately, much of the desire and nostalgia rests in the physical look and flow of the comic book which existing digital readers have not been able to replicate. Additionally, existing digital readers are not small and convenient enough for a user to carry with them at all times.

These and other deficiencies have left comic book aficionados without an acceptable, mobile, hand-held, electronic comic book platform that retains both the highly sought after physical characteristics and flow of traditional printed comic books.

### BRIEF SUMMARY OF THE INVENTION

The present invention relates to a method, system, and storage medium for a comic book reader platform.

A technical advantage of the disclosed subject matter is the ability for a user to load multiple comic books onto a hand-held mobile device.

Another technical advantage of the disclosed subject matter is the ability to easily switch between multiple comic books through an intuitive bookshelf feature.

Yet another technical advantage of the disclosed subject matter is the ability to easily switch between full page mode and cell-by-cell mode.

Another technical advantage of the disclosed subject matter is implementing advanced features contained in newer hand-held mobile devices (e.g. touch screens, motion sensitivity, etc.) to enhance the overall user experience.

An additional technical advantage of the disclosed subject matter is preserving the look and flow of traditional printed comic books in a hand-held mobile device.

These and other features will be readily apparent to those with skill in the art in conjunction with this disclosure.

### BRIEF DESCRIPTIONS OF THE DRAWINGS

In some instances, the invention is depicted as simplified model schematics to represent the basic constructs and concepts for the application.

The features, nature, and advantages of the disclosed subject matter will become more apparent from the detailed description set forth below when taken in conjunction with the accompanying drawings, wherein:

FIG. 1 depicts a flow chart of the basic user experience of the preferred embodiment.

FIG. 2 depicts an example of the page transition options of the preferred embodiment.

FIG. 3 depicts a graphic of the bookshelf feature of the preferred embodiment.

FIG. 4 depicts a graphic of the cover of the selected book.

FIG. 5 depicts a graphic of a page contained within the selected book in vertical mode.

FIGS. 6a, 6b, and 6c depict graphical views of cells within the selected page of the selected book in horizontal mode.

### DETAILED DESCRIPTION OF THE INVENTION

Although described with reference to specific embodiments, one skilled in the art could apply the principles discussed herein to other areas and/or embodiments.

Throughout this disclosure the words hand-held mobile device and mobile device are used interchangeably and are intended to include devices such as personal digital assistants, smart phones, mobile digital assistants, multi-media enabled phones, multi-media enabled smart phones, netbooks, tablet computers, and the like.

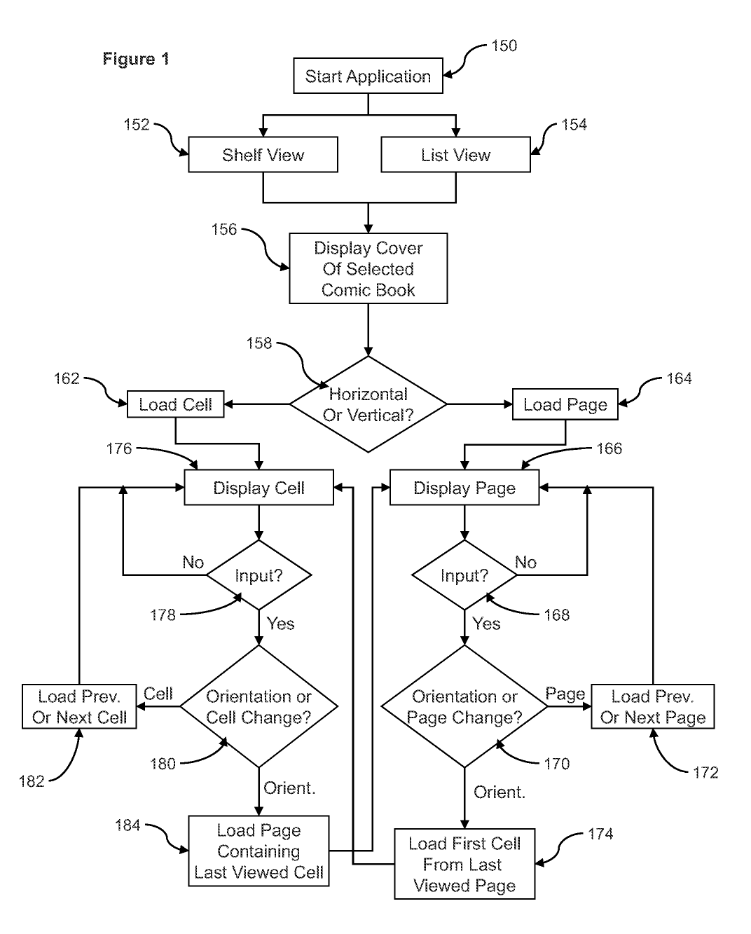

FIG. 1 depicts a flow chart of the basic user experience of an embodiment. When a user starts the application 150 the user is presented with either a shelf view 152 or a list view 154. The shelf view 152 depicts each of the user's comic books as if displayed on a bookshelf. The cover art of each comic book is shown. The list view 154 shows the comic books in a list format. The list format can be sorted by items such as: title, publisher, publication date, edition number, user rating, read/unread status, etc. Regardless of whether shelf view 152 or list view 154 is used, the user need only select the desired comic book to start reading (selection input). After the user selects the desired comic book, the cover art of that comic book is briefly shown to the user 156. If implemented on a mobile device that has both vertical and horizontal display modes, the application detects which mode the mobile device is currently set 158.

If the device is in vertical display mode, the first page of the comic book is loaded 164 and shown 166. Additionally, if the user had previously read the comic book, the software could store where the user left off and open the comic book directly to the last viewed page. In another embodiment, the user would be asked if they would like to restart the comic book or go to the last page viewed.

The mobile device would then wait for some form of input or change 168. For example, if the user changed the orientation of the device (changed from vertical to horizontal viewing mode) 170, the application would load the first cell of the page the user was viewing immediately before the viewing mode changed 174. Then the application would display the cell 176. However, if the input 168 was just a page change 170 (page/cell change input), then the application would load the previous or next page dependent on the user's input 172 and display the page 166. This process continues indefinitely until the user switches comic books, closes the application, or changes the settings of the application.

Returning to step 158, if the mobile device was in horizontal mode, the application would either load the first cell of the comic book or the last cell the user viewed the last time the user read that particular comic book 162. If the last time the user read that particular comic book, the user was in vertical mode (therefore viewing a full page of the comic book), the application would load the first cell of the last full page viewed in vertical mode. Similar to vertical mode, the application would then display the loaded cell 176 and wait for input 178.

If an orientation change was detected 180 then the application would load the page containing the cell 184 and then display the page 166. If a cell change (page/cell change input) was detected 180, then the previous or next cell, depending on the user's input, would be loaded 182 and displayed 176. As in the vertical orientation (full page mode), the cell-by-cell mode continues indefinitely until the user switches comic books, closes the application, or changes the settings of the application.

In an embodiment, each cell on a page is linked to that page. For example, if page 1 had five cells, then each cell could be labeled 1a, 1b, 1c, 1d, and 1e. This allows easy switching between vertical and horizontal orientations as well as an easy way to save the user's place in a comic book. Therefore, continuing this example, if the user is in horizontal orientation mode (cell-by-cell) viewing cell 1d and then switched to vertical orientation mode (full page), the application knows which full page to display—page 1. Alternately, if the user is viewing page 1 and switches to horizontal mode, the application knows which cell to display.

This reader experience provides the user the ability to view each cell in context to other cells in the vertical orientation (full page mode) and gives the user a better understanding and appreciation for the author's full vision. It also preserves the look and flow of a traditional paper based comic book. Additionally, the user has the opportunity to view the comic book in a horizontal orientation (cell-by-cell mode) to better see the detail contained in that particular cell.

Although the preceding orientation discussion (vertical mode displaying full page and horizontal displaying cell-by-cell) is one embodiment, throughout this disclosure, depending on the particular type of mobile device and/or the particular user's desire, horizontal mode and vertical mode, as discussed throughout, could be switched such that horizontal mode displays a complete page and vertical mode displays individual cells.

The application also takes advantage of the advanced features available in today's mobile devices to enhance the user experience and preserve the flow of traditional comic books. As a means of example, but not of limitation, in certain mobile devices, such as the iPhone® (a registered trademark of Apple Inc.), switching between vertical and horizontal orientations is as easy as physically changing the orientation of the mobile device and switching between pages is as simple as a flick of the finger.

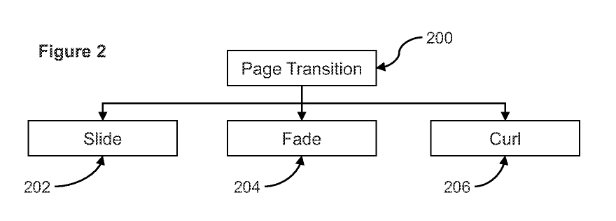

FIG. 2 depicts an example of the page transition options 200 of the preferred embodiment. Again, to preserve the look and flow of traditional paper based comic books, the application provides several page/cell transition options. As a means of example, but not of limitation, the user could select: slide 202, fade 204, or curl 206. In slide 202 mode, when the application detected a previous or next page input 170, then the old page would appear to slide across the mobile device's screen as it was replaced by the previous or next page. Similarly, if the user selected fade 204 mode, the current page would fade and be replaced by the previous or next page. Finally, if the user chose curl 206 mode, the current page would curl away to reveal the previous or next page “beneath” it. This would work similarly for cells in horizontal orientation (cell-by-cell).

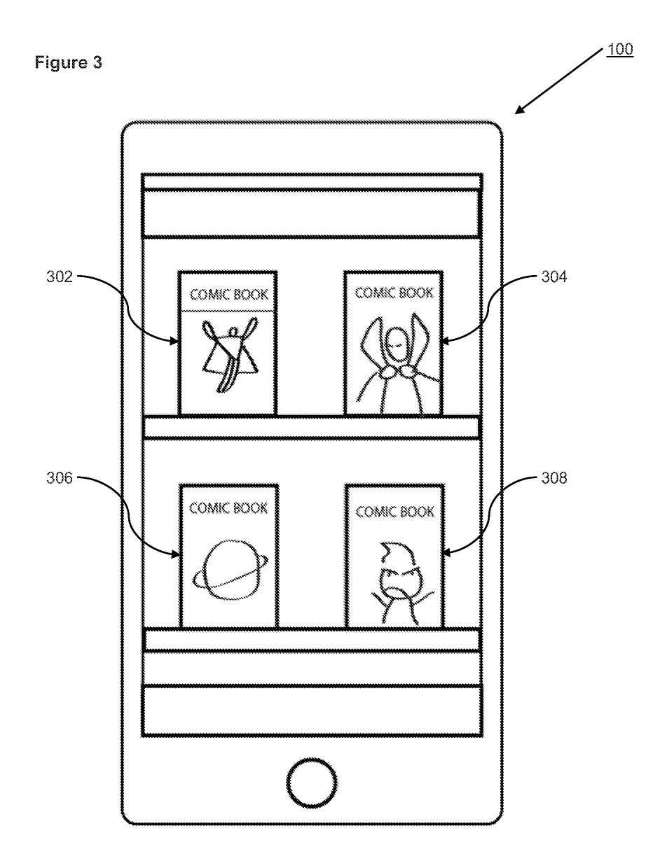

FIG. 3 depicts a graphic of the bookshelf feature of the preferred embodiment. As briefly discussed earlier, when in bookshelf mode, the mobile device 100 displays the user's comic books as if on a bookshelf. Each individual comic book's cover art 302, 304, 306, and 308 is displayed so the user could choose which comic book he or she wanted to read. If there were more comic books available than could be viewed on one “bookshelf” the application would permit the user to scroll through multiple “bookshelves.” Additionally, as with the list view, the user could sort the comic books so they appear on the bookshelf in a particular order.

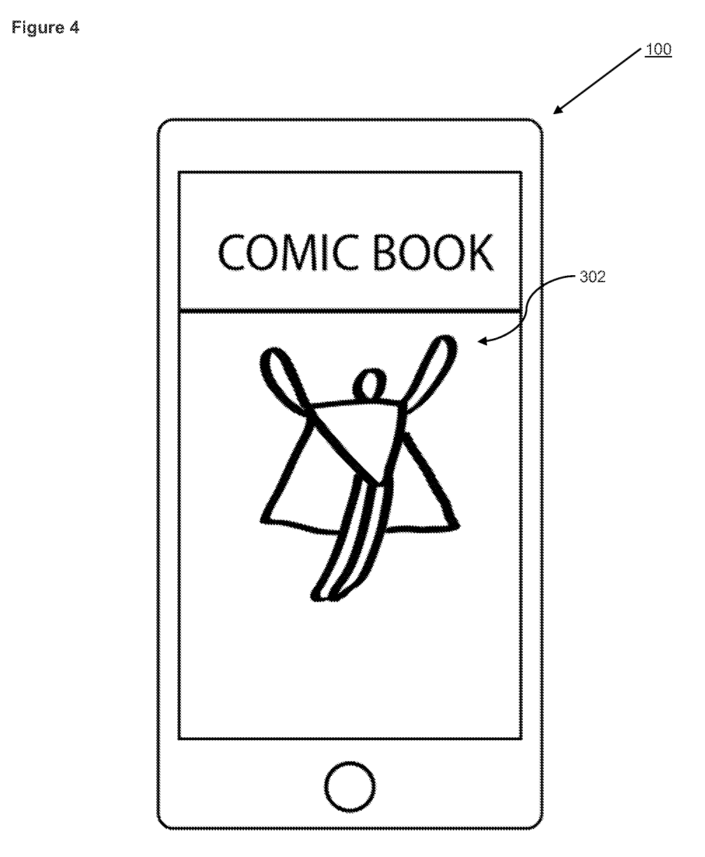

FIG. 4 depicts a graphic of the cover of the selected book. Once the user selected a particular comic book to read, the cover art of the chosen comic book 302 would be briefly displayed before proceeding to a page within the chosen comic book.

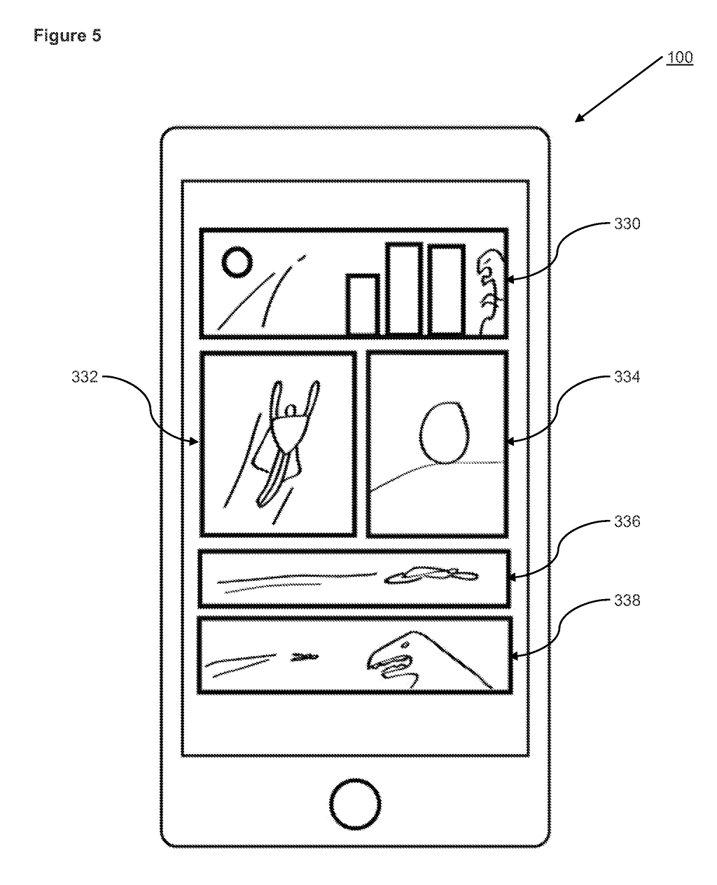

FIG. 5 depicts a graphic of a page contained within the selected comic book in vertical mode. In vertical mode, the mobile device 100 displays a complete page of the chosen comic book. This way the user can view the entire page the way the author/artist intended it to be viewed. It allows the user to see each individual cell of the page in context with the other cells. As this Figure depicts, cells can be broken into several different formats and shapes. For example, the first cell 330 is a horizontal rectangle, where as the next two cells 332 and 334 are vertical rectangles taller but narrower than the first cell. Finally, the last two cells 336 and 338 are narrow horizontal cells. Furthermore, 332 and 334 could form a single cell the same as 336 and 338 could form a single cell. This helps to show the flexibility of the underlying application.

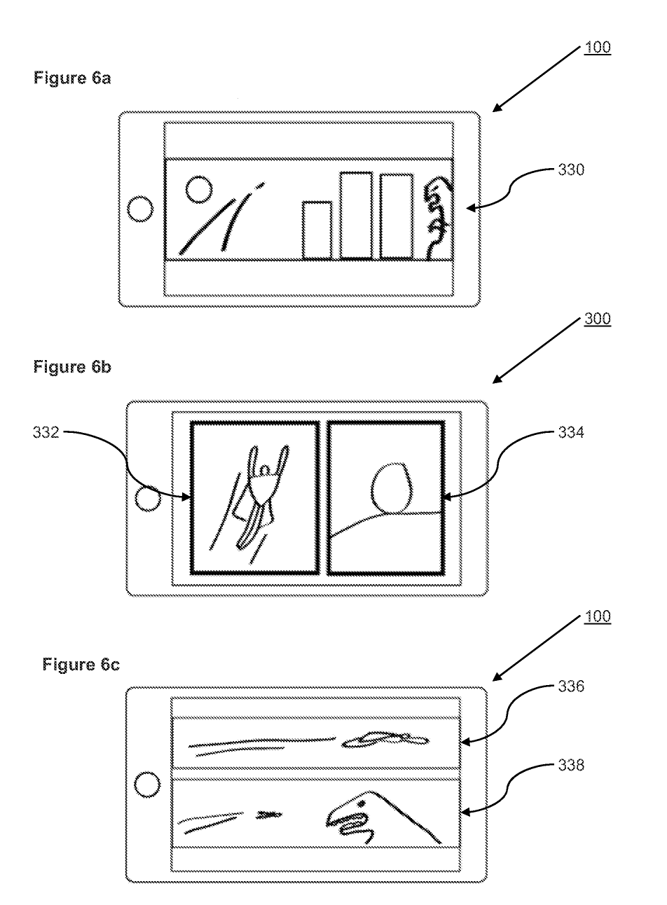

FIGS. 6a, 6b, and 6c depict graphical views of cells within the selected page of the selected book in horizontal mode. FIG. 6a, depicts the first cell 330 in horizontal mode. FIG. 6b, depicts the second and third cells 332 and 334, respectively, as if they were a single cell. Finally, FIG. 6c, depicts the fourth and fifth cells 336 and 338, respectively, as if they were a single cell.

Although described with reference to comic books, this disclosure is intended to include other forms of books. Furthermore, the invention, as described, covers the scope of functionality in a holistic way. Although described with reference to particular embodiments, those skilled in the art, with this disclosure, will be able to apply the teachings in principles in other ways. All such additional embodiments are considered part of this disclosure and the accompanying claims.

What is claimed is:

1. A system for a comic book reader platform, the system comprising:
a mobile device, said mobile device comprising:
a display;
a processor; and
a storage medium;
said processor capable of executing instructions stored on said storage medium, said instructions comprising the steps of:
displaying one or more comic books on said display according to a view, said view either a list view or a bookshelf view, said comic books stored on said storage medium, and said comic books comprising:
a cover; and
at least one page, said page having at least one cell;
displaying said cover of a particular comic book on said display in response to a selection input, said particular comic book one of said comic books and said cover associated with said particular comic book;
determining an orientation of said mobile device, said orientation either generally vertical or generally horizontal; and
displaying on said display either said page of said particular comic book or one of said cells on said page according to said orientation.

2. The system of claim 1, wherein said bookshelf view displays on said display a plurality of said covers associated with said comic books.

3. The system of claim 1, said instructions additionally comprising the step of determining a change in said orientation of said mobile device and in response to said change toggling between:
displaying on said display one of said cells of said page; or
displaying on said display said page containing said cell.

4. The system of claim 1, said instructions additionally comprising the step of determining a page/cell change input and in response to said page/cell change input displaying:
a previous page;
a later page;
a previous cell; or
a later cell.

5. The system of claim 1, said instructions additionally comprising the steps of:
determining a change in said orientation of said mobile device and in response to said change toggling between:
displaying on said display one of said cells of said page; or
displaying on said display said page containing said cell; and
determining a page/cell change input and in response to said page/cell change input displaying:
a previous page;
a later page;
a previous cell; or
a later cell.

6. The system of claim 5, wherein said bookshelf view displays on said display a plurality of said cover pages associated with said comic books.

7. The system of claim 1, wherein said generally vertical orientation is associated with said pages and said generally horizontal orientation is associated with said cells.

8. The system of claim 1, wherein said generally vertical orientation is associated with said cells and said generally horizontal orientation is associated with said pages.

9. A tangible storage medium, said storage medium encoded with a program for a comic book reader platform, said program executable on a mobile device, said program comprising the steps of:
displaying one or more comic books on a display according to a view, said view either a list view or a bookshelf view, said comic books stored on the storage medium, and said comic books comprising:
a cover; and
at least one page, said page having at least one cell;
displaying said cover of a particular comic book on said display in response to a selection input, said particular comic book one of said comic books and said cover associated with said particular comic book;
determining an orientation of the mobile device, said orientation either generally vertical or generally horizontal; and
displaying on said display either said page of said particular comic book or said cell on said page according to said orientation.

10. The storage medium of claim 9, wherein said bookshelf view displays on said display a plurality of said cover pages associated with said comic books.

11. The storage medium of claim 9, said instructions additionally comprising the step of determining a change in said orientation of the mobile device and in response to said change toggling between:
displaying on said display one of said cells of said page; or
displaying on said display said page containing said cell.

12. The storage medium of claim 9, said instructions additionally comprising the steps of:
determining a change in said orientation of the mobile device and in response to said change toggling between:
displaying on said display one of said cells of said page; or
displaying on said display said page containing said cell; and
determining a page/cell change input and in response to said page/cell change input displaying:
a previous page;
a later page;
a previous cell; or
a later cell.

13. The storage medium of claim 12, wherein said bookshelf view displays a plurality of said cover pages associated with said comic books on said display.

14. The storage medium of claim 9, wherein said generally vertical orientation is associated with said pages and said generally horizontal orientation is associated with said cells.

15. A method for a comic book reader platform, the method performed on a mobile device, the method comprising the steps of:
displaying one or more comic books on a display according to a view, said view either a list view or a bookshelf view, said comic books stored on a storage medium, and said comic books comprising:
a cover; and
at least one page, said page having at least one cell;
displaying said cover of a particular comic book on said display in response to a selection input, said particular comic book one of said comic books and said cover associated with said particular comic book;
determining an orientation of the mobile device, said orientation either generally vertical or generally horizontal; and
displaying on said display either said page of said particular comic book or said cell on said page according to said orientation.

16. The method of claim 15, wherein said bookshelf view displays on said display a plurality of said cover pages associated with said comic books.

17. The method of claim 15, said instructions additionally comprising the step of determining a change in orientation of the mobile device and in response to said change toggling between:
displaying on said display one of said cells of said page; or
displaying on said display said page containing said cell.

18. The method of claim 15, said instructions additionally comprising the steps of:
determining a change in orientation of the mobile device and in response to said change toggling between:
displaying on said display one of said cells of said page; or
displaying on said display said page containing said cell; and
determining a page/cell change input and in response to said page/cell change input displaying:
a previous page;
a later page;
a previous cell; or
a later cell.

19. The method of claim 18, wherein said bookshelf view displays a plurality of said cover pages associated with said comic books on said display.

20. The method of claim 15, wherein said vertical orientation is associated with said pages and said horizontal orientation is associated with said cells.
